(19) United States
(12) Patent Application Publication
(10) Pub. No.: US 2006/0205457 A1
(43) Pub. Date: Sep. 14, 2006

(54) SYSTEMS AND METHODS FOR PROCESSING WAGER GAMING MESSAGES

(76) Inventors: Christopher W. Blackburn, Reno, NV (US); Nicholas M. Gadacz, Reno, NV (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/275,323

(22) Filed: Dec. 22, 2005

Related U.S. Application Data
(60) Provisional application No. 60/640,582, filed on Dec. 31, 2004.

(51) Int. Cl. A63F 13/00

(52) U.S. Cl. 463/1

(57) ABSTRACT

Systems and methods for processing wager gaming messages are described herein. In one embodiment, one of the methods includes receiving a wager gaming message from a wager gaming network device. The method also includes selecting a message queue for receiving the wager gaming message, where the wager gaming network device does not select the message queue. The method also includes transmitting the wager gaming message to the message queue.

### RELATED APPLICATION

This application claims priority under 35 U.S.C. 119(e) from U.S. Provisional Application Ser. No. 60/640,582 filed Dec. 31, 2004, which application is incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, WMS Gaming, Inc.

### FIELD

This invention relates generally to the field of wagering game machines and more particularly to the field of communications in a wager gaming network.

### BACKGROUND

Wagering game machines, wager gaming computer systems, and peripheral devices can be employed in wager gaming networks. In some wager gaming networks, the network devices communicate by exchanging messages. For example, wagering game machines can report jackpot winnings by transmitting messages across a wager gaming network to a jackpot controller. Similarly, wager gaming accounting systems can collect wagering game data (e.g., betting amounts, payout information, etc.) by receiving messages from the wagering game machines.

In some wager gaming networks, each network device includes logic for determining where in the network to transmit messages. In particular, each wagering game machine may be equipped with hardware and/or software for determining where to send jackpot messages, reporting messages, printer messages, security warning messages, participation style wager gaming messages, etc. Each of these messages may be sent to different network devices and the messages may conform to different communication protocols.

One disadvantage of such wager gaming networks is that expensive message transmission logic may be replicated in every wagering game machine and device of the network. Another disadvantage is that each network device's transmission logic may require complete software recompilation when devices are added or removed from the wager gaming network. When software is recompiled, wager gaming regulators may require lengthy testing and analysis.

### BRIEF DESCRIPTION OF THE FIGURES

The present invention is illustrated by way of example and not limitation in the Figures of the accompanying drawings in which:

FIG. 1 is a dataflow diagram illustrating dataflow attendant to transmitting messages in a wager gaming network, according to embodiments of the invention;

FIG. 2 is a block diagram of an exemplary wager gaming network, according to embodiments of the invention;

FIG. 3 is a perspective view of a wagering game machine, according to exemplary embodiments of the invention;

FIG. 4 is a block diagram illustrating a wager gaming network device, according to exemplary embodiments of the invention;

FIG. 5 is a block diagram illustrating a message queue selector, according to exemplary embodiments of the invention;

FIG. 6 is a flow diagram illustrating operations for sending messages to a message queue selector, according to exemplary embodiments of the invention;

FIG. 7 is a flow diagram illustrating operations for determining queues to which messages will be sent, according to exemplary embodiments of the invention;

FIG. 8 is a flow diagram illustrating operations for requesting and receiving wager gaming messages from message queues, according to exemplary embodiments of the invention; and

FIG. 9 is a block diagram illustrating database tables used for routing messages in a wager gaming network, according to exemplary embodiments of the invention.

### DESCRIPTION OF THE EMBODIMENTS

Systems and methods for processing wager gaming messages are described herein. This description of the embodiments is divided into four sections. The first section describes an overview, while the second section describes an exemplary operating environment and system architecture. The third section describes exemplary operations and the fourth section provides some general comments.

### Overview

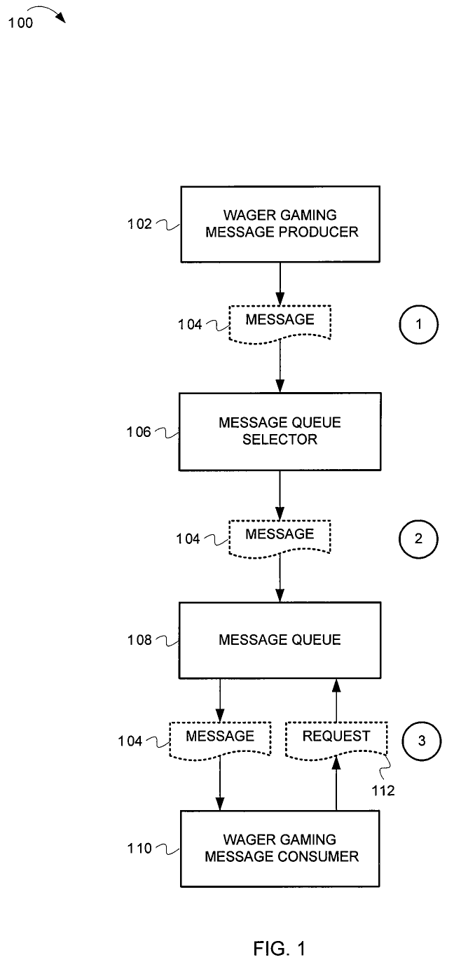

This section provides a broad overview of a wager gaming messaging system. In particular, this section describes a wager gaming network in which devices transmit messages to a central message queue selector that forwards the messages to appropriate message queues. Additional details are discussed below, in the description of FIG. 1.

FIG. 1 is a dataflow diagram illustrating dataflow attendant to transmitting messages in a wager gaming network, according to embodiments of the invention. Messages can include wager gaming information, task requests (e.g., a request to print data), system information (e.g., information for maintaining operability of the network), etc. The dataflow 100 of FIG. 1 is divided into three stages.

At stage one, a wager gaming message producer 102 transmits a message 104 to a message queue selector 106. The wager gaming message producer 102 can be any wager gaming network device (e.g., a wagering game machine, printer, etc.), while the message queue selector can include a database (e.g., a relational database). In one embodiment, stage one's message transmission can be a result of the wager gaming message producer 102 making a direct database call to the message queue selector 106.

At stage two, the message queue selector 106 transmits the message 104 to a message queue 108. The message queue selector 106 can transmit messages to the message queue 108 using database triggers. The message queue 108 can reside in the same database that includes the message queue selector 106. Alternatively, the message queue 108 can reside in a separate data store.

At stage three, a wager gaming message consumer 110 requests a message from the message queue 108. In response to the message request 112, the message queue 108 transmits the message 104 to the wager gaming message consumer 110. Alternatively, the wager gaming message consumer 110 can “attach” itself to the message queue 108, where the message queue 108 will forward messages to the wager gaming message consumer 110 as the messages arrive in the message queue 108. The message consumer can be any network device, such as a wager gaming machine, printer, jackpot controller, etc. In one embodiment, the message queue 108 transmits the message 104 in response to a request from the wager gaming message consumer 110.

While this overview describes dataflow and operations performed by certain embodiments of the invention, other embodiments exhibit different dataflow and operations, as described in greater detail below. The next section describes an exemplary wager gaming network and network devices, according to embodiments of the invention.

### Hardware, Operating Environment, and System Architecture

This section describes a wager gaming network and its devices, according to embodiments of the invention. Operations of the system devices will be described in the next section.

### Wager Gaming Network

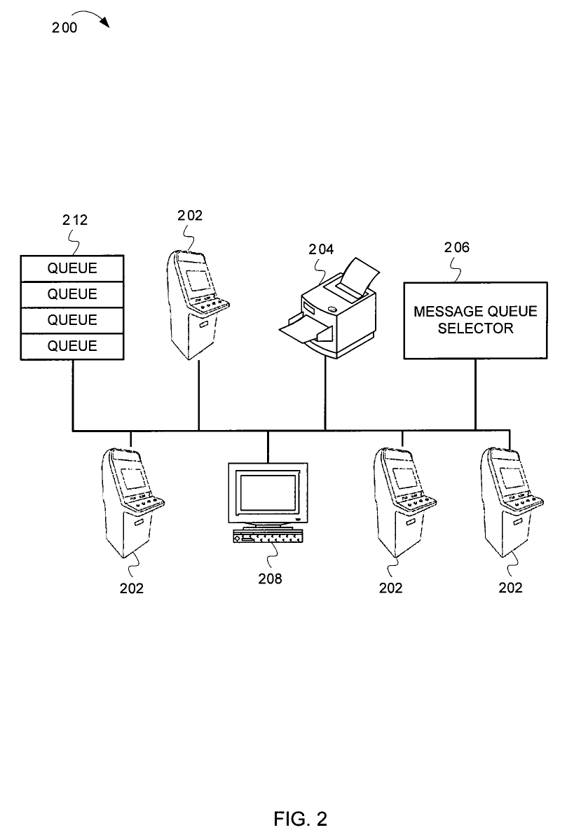

FIG. 2 is a block diagram of an exemplary wager gaming network, according to embodiments of the invention. Operations of wager gaming network devices are described in greater detail below, in the next section. As shown in FIG. 2, a wager gaming network 200 includes a plurality of wagering game machines 202, a printer 204, site controller 208, message queue selector 206, and message queues 212. The wager gaming network 200 can also include other suitable network devices.

These devices of the wager gaming network 200 can communicate over wired and/or wireless connections. The network devices can be connected to the wager gaming network 200 using any suitable connection technology, such as Bluetooth, 802.11x, Ethernet, DSL, etc.

The site controller 208 can be located in a casino and can be used for monitoring wagering game machine information, such as amounts wagered, amounts paid-out, amounts collected, and player tracking information. The message queue selector 206 can receive messages from any network device (e.g., through a direct database call) and forward those messages to appropriate queues in the message queues 212. The message queues 212 can store and transmit the messages to appropriate network devices. In one embodiment, the printer 204 or other network devices can receive messages from the message queues 212 and perform operations based on the messages.

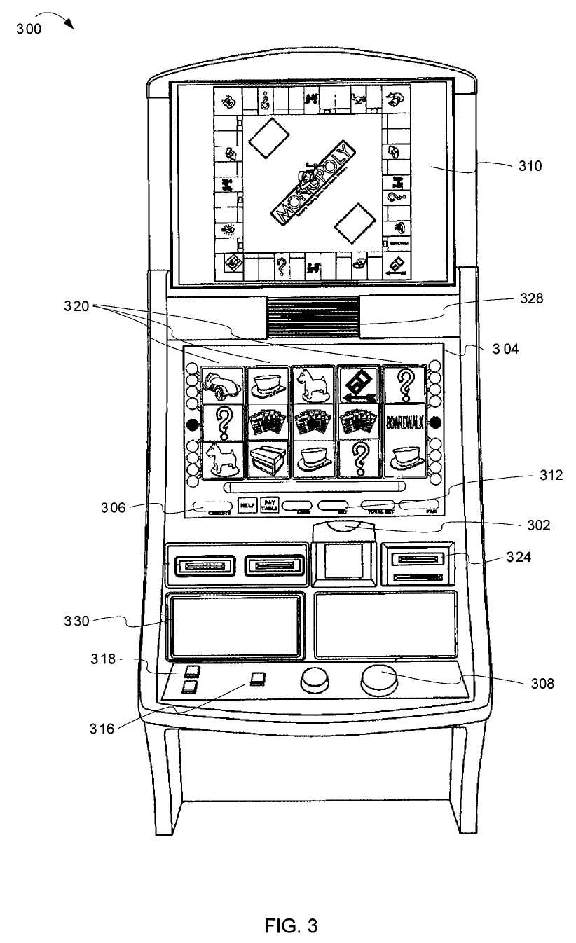

While FIG. 2 describes a wager gaming network, FIG. 3 describes wagering game machines in greater detail. According to embodiments, the wagering game machines send and receive messages as described herein.

FIG. 3 is a perspective view of a wagering game machine, according to exemplary embodiments of the invention. As shown in FIG. 3, the wagering game machine 300 can be a computerized slot machine having the controls, displays, and features of a conventional slot machine.

The wagering game machine 300 can be operated while players are standing or seated. Additionally, the wagering game machine 300 is preferably mounted on a stand (not shown). However, it should be appreciated that the wagering game machine 300 can be constructed as a pub-style tabletop game (not shown), which a player can operate while sitting. Furthermore, the wagering game machine 300 can be constructed with varying cabinet and display designs. The wagering game machine 300 can incorporate any primary game such as slots, poker, or keno, and additional bonus round games. The symbols and indicia used on and in the wagering game machine 300 can take mechanical, electrical, or video form.

As illustrated in FIG. 3, the wagering game machine 300 includes a coin slot 302 and bill acceptor 324. Players can place coins in the coin slot 302 and paper money or ticket vouchers in the bill acceptor 324. Other devices can be used for accepting payment. For example, credit/debit card readers/validators can be used for accepting payment. Additionally, the wagering game machine 300 can perform electronic funds transfers and financial transfers to procure monies from financial accounts. When a player inserts money in the wagering game machine 300, a number of credits corresponding to the amount deposited are shown in a credit display 306. After depositing the appropriate amount of money, a player can begin playing the game by pushing play button 308. The play button 308 can be any play activator used for starting a wagering game or sequence of events in the wagering game machine 300.

As shown in FIG. 3, the wagering game machine 300 also includes a bet display 312 and a “bet one” button 316. The player places a bet by pushing the bet one button 316. The player can increase the bet by one credit each time the player pushes the bet one button 316. When the player pushes the bet one button 316, the number of credits shown in the credit display 306 decreases by one credit, while the number of credits shown in the bet display 312 increases by one credit.

A player may “cash out” by pressing a cash out button 318. When a player cashes out, the wagering game machine 300 dispenses a voucher or currency corresponding to the number of remaining credits. The wagering game machine 300 may employ other payout mechanisms such as credit slips (which are redeemable by a cashier) or electronically recordable cards (which track player credits), or electronic funds transfer.

The wagering game machine also includes a primary display unit 304 and a secondary display unit 310 (also known as a “top box”). The wagering game machine may also include an auxiliary video display 330. In one embodiment, the primary display unit 304 displays a plurality of video reels 320. According to embodiments of the invention, the display units 304 and 310 can include any visual representation or exhibition, including moving physical objects (e.g., mechanical reels and wheels), dynamic lighting, and video images. In one embodiment, each reel 320 includes a plurality of symbols such as bells, hearts, fruits, numbers, letters, bars or other images, which correspond to a theme associated with the wagering game machine 300. Furthermore, as shown in FIG. 3, the wagering game machine 300 includes a audio presentation unit 328. The audio presentation unit 328 can include audio speakers or other suitable sound projection devices.

In one embodiment, the wagering game machine 300 can transmit messages to a message queue selector and receive messages from a message queue, as described herein.

### Wager Gaming Network Device Architecture

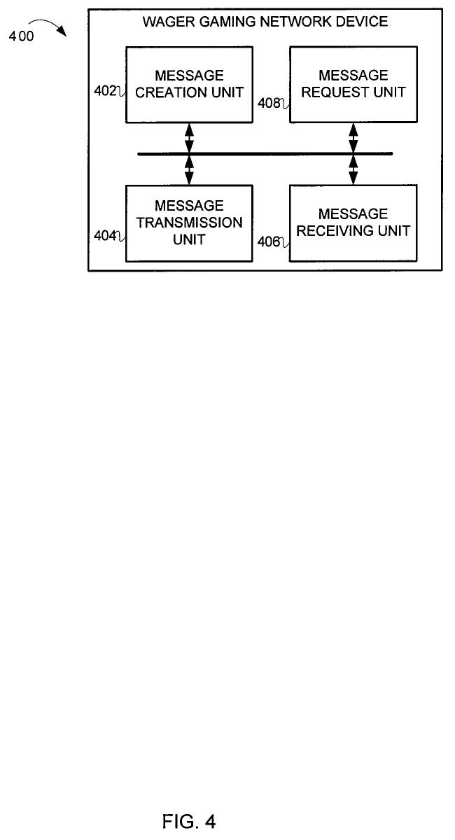

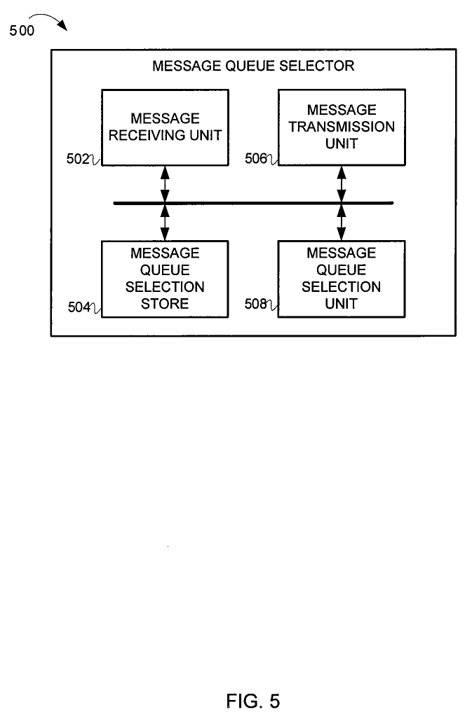

The following discussion of FIGS. 4 and 5 sets forth exemplary architectures for wager gaming network devices, according to embodiments of the invention.

FIG. 4 is a block diagram illustrating a wager gaming network device, according to exemplary embodiments of the invention. The wager gaming network device 400 can be any suitable device (e.g., any of the network devices of FIG. 2). The wager gaming network device 400 includes a message creation unit 402, message transmission unit 404, message receiving unit 406, and a message request unit 408. In one embodiment, wager gaming network devices such as printers, wagering game machines, and site controllers include additional functional units, which are not shown.

In one embodiment, the message creation unit 402 can create messages that will be transmitted across a wager gaming network. Messages can include wager gaming information, task requests, system information, or other information used by a device of a wager gaming network.

The message transmission unit 404 can transmit messages across a wager gaming network to a message queue selector 206. The message transmission unit 404 can encapsulate and/or format messages according to any suitable communication protocol, such as the Internet Protocol (IP), RS-232, RS-400, 802.11g, etc. The message transmission unit 404 can be connected to any suitable transmission medium, such as RS-232, RS-400, 802.11g, Ethernet, etc.

The message receiving unit 406 can receive messages from wager gaming network devices, while the message request unit 408 can request messages from ones of the message queues 212.

FIG. 5 is a block diagram illustrating a message queue selector, according to exemplary embodiments of the invention. As shown in FIG. 5, a message queue selector 500 includes a message receiving unit 502, message transmission unit 506, message queue selection unit 508, and message queue selection store 504. In one embodiment, the message queue selection store 500 can be a database. In such a database, the units 502, 506, and 508 can be stored database procedures, while unit 504 can be a database table.

The message receiving unit 502 can receive messages from network devices. In one embodiment, the message receiving unit 502 can be a stored database procedure that receives messages or parameters from network devices. In another embodiment, the message receiving unit 502 can include any suitable logic (e.g., database functionality, application programs, etc.) for receiving messages from network devices. In one embodiment, the message receiving unit 502 can receive messages in the form of character strings (e.g., XML strings). The message receiving unit 502 can also receive parameter lists, which include parameter values, such as wager gaming device MAC addresses, game theme identifiers, and progressive identifiers.

The message transmission unit 506 can transmit messages to appropriate message queues 212. In one embodiment, the message transmission unit 506 can be a database trigger that transmits messages to the message queues 212. Alternatively, the message transmission unit 506 can include any suitable logic (e.g., database procedure, application program, etc.) for transmitting messages to the message queues 212.

The message queue selection unit 508 uses information in the message queue selection store 504 for determining to which queues it will send messages. In one embodiment, the message queue selection store 504 stores lists of queues that are associated with different message types. These lists can be represented in a set of one or more database tables. For example, the message queue selection store 504 can include database tables including a list of queues associated with printer messages, another list of queues associated with wagering game machine messages, and yet another list of queues associated with cluster controller messages. In one embodiment, the message queue selection unit 508 can designate a particular message for transmission to several message queues, according to the lists stored in the message queue selection store 504. The message queue selection unit 508 can be a database procedure or any other suitable logic.

In one embodiment, the components of the wager gaming network device 400 and the message queue selector 500 can be integrated or divided, forming any number of devices. According to embodiments, the components can include queues, stacks, or other data structures necessary for performing the functionality described herein. Moreover, the modules can be communicatively coupled using any suitable communication method (message passing, parameter passing, signals, etc.).

Any of the devices used in conjunction with embodiments of the invention can include machine-readable media for performing operations described herein. Machine-readable media includes any mechanism that provides (i.e., stores and/or transmits) information in a form readable by a machine (e.g., a computer). For example, machine-readable media includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc. According to embodiments of the invention, the devices can be other types of logic (e.g., digital logic) for executing the operations for processing messages in a wager gaming network.

### Operations

This section describes operations performed by embodiments of the invention. In certain embodiments, the operations are performed by instructions residing on machine-readable media (e.g., software), while in other embodiments, the methods are performed by hardware or other logic (e.g., digital logic).

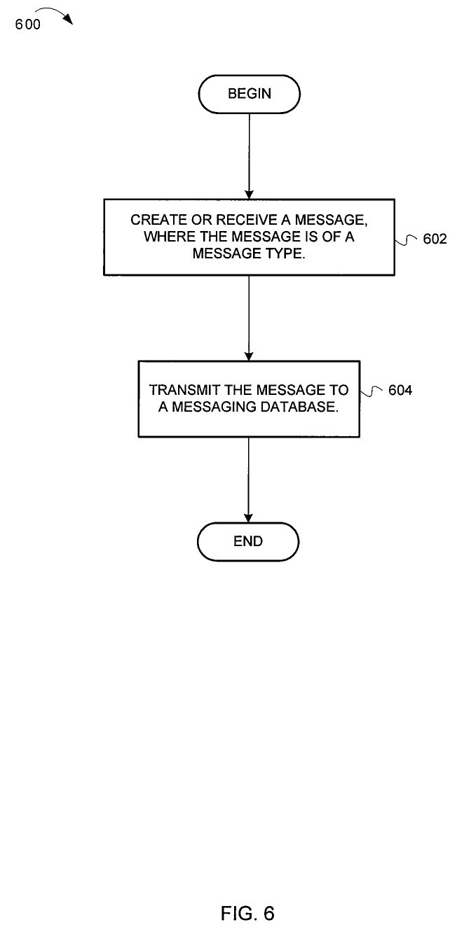

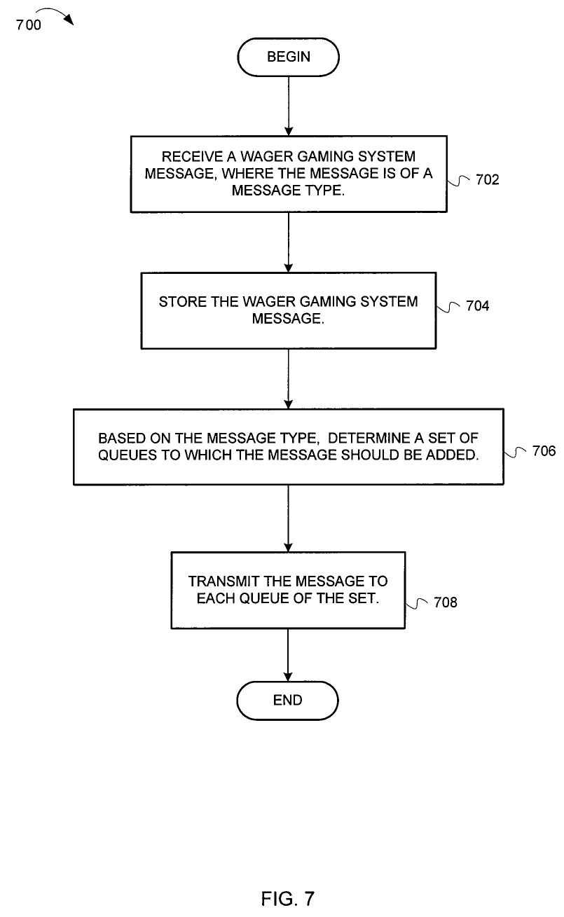

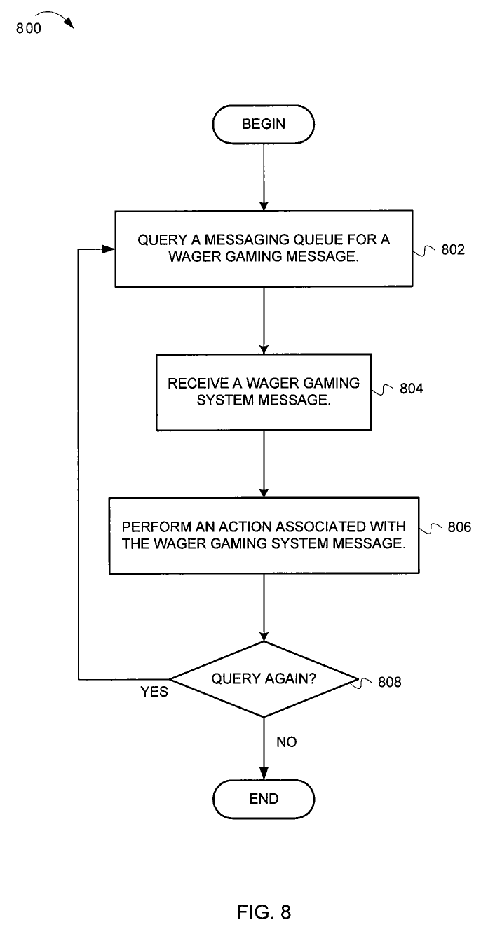

In this section, FIGS. 6-8 will be discussed. In particular, FIG. 6 describes operations for sending messages to a message queue selector, while FIG. 7 describes operations for transmitting messages to selected message queues. FIG. 8 describes operations for consuming messages from the messages queues.

FIG. 6 is a flow diagram illustrating operations for sending messages to a message queue selector, according to exemplary embodiments of the invention. The flow diagram 600 will be described with reference to the exemplary wager gaming network shown in FIG. 2. The flow diagram 600 commences at block 602.

At block 602, a message is created, where the message is associated with a message type. For example, a wager gaming network device's message creation unit 402 creates a message. The message can be of any type supported by the message queue selection store 504. For example, the message can be associated with a “printer message type” or a “site controller message type.” In one embodiment, instead of creating the message, the wager gaming network device receives the message from another network device. The flow continues at block 604.

At block 604, the message is transmitted to a message queue selector. For example, the wager gaming network device's message transmission unit 404 transmits the message to a message queue selector 500. In one embodiment, the message is received by other network devices before arriving at the message queue selector 500. From block 604, the flow ends.

While FIG. 6 describes operations for sending messages to a message queue selector, FIG. 7 describes operations for processing the messages in the message queue selector.

FIG. 7 is a flow diagram illustrating operations for determining queues to which messages will be sent, according to exemplary embodiments of the invention. The flow diagram 700 will be described with reference to the exemplary embodiments shown in FIGS. 2 and 5. The flow diagram 700 commences at block 702.

At block 702, a message is received, where the message is of a message type. For example, a message queue selector 500 receives a message in its message receiving unit 502. The message can be of a particular message type. For example, the message can be of a message type that can be processed by a printer or other wager gaming network device (e.g., a wagering game machine 202 or cluster controller 208). In one embodiment, the message can include an identifier indicating the message type. The flow continues at block 704.

At block 704, the message is stored. For example, the message queue selector's message queue selection unit 508 stores the wager gaming message in a storage buffer (not shown). The flow continues at block 706.

At block 706, based on the wager gaming message type, the message queue selector 500 determines a set of queues to which the wager gaming message will be added. In one embodiment, the message queue selection unit 508 uses the message type, which it determines by inspecting an identifier included in the wager gaming message, as a key into the message queue selection store 504. The message queue selection store 504 maintains lists of queues to which the wager gaming message should be added. In one embodiment, the message queue selection store 504 returns a set of one or more queues corresponding to the key. The flow continues at block 708.

At block 708, the wager gaming message is transmitted to each queue of the set. For example, the message queue selector's message transmission unit 506 transmits the wager gaming message one or more of the queues 212. From block 708, the flow ends.

While the discussion of FIG. 7 described operations for selecting message queues and transmitting messages, FIG. 8 describes operations for requesting and receiving messages from the message queues.

FIG. 8 is a flow diagram illustrating operations for requesting and receiving wager gaming messages from message queues, according to exemplary embodiments of the invention. The flow diagram 800 will be described with reference to the exemplary embodiments shown in FIGS. 2 and 4. The flow diagram 800 commences at block 802.

At block 802, a message queue is queried for a wager gaming message. For example, a wager gaming network device's message request unit 408 transmits a request for a wager gaming message to one of the message queues 212. The flow continues at block 804.

At block 804, a message is received. For example, a wager gaming network device's message receiving unit 406 receives a wager gaming message from the message queue. In one embodiment, the message queues 212 transmit wager gaming messages to network devices in response to message requests. The flow continues at block 806.

At block 806, based on the message, an operation is performed. For example, based on the message, the wager gaming network device performs an operation. Operations depend on the capabilities of the wager gaming network device and can include printing data included in the wager gaming message, storing wager gaming information contained within the wager gaming message, and authorizing payment of a jackpot. In one embodiment, the wager gaming network device can perform any suitable operation. The flow continues at block 808.

At block 808, a determination is made about whether another query of the message queues will be made. For example, a wager gaming network device's message request unit 408 determines whether it will again query the message queues 212. If another query will be made, the flow continues at block 802. Otherwise, the flow ends.

### Implementation Details

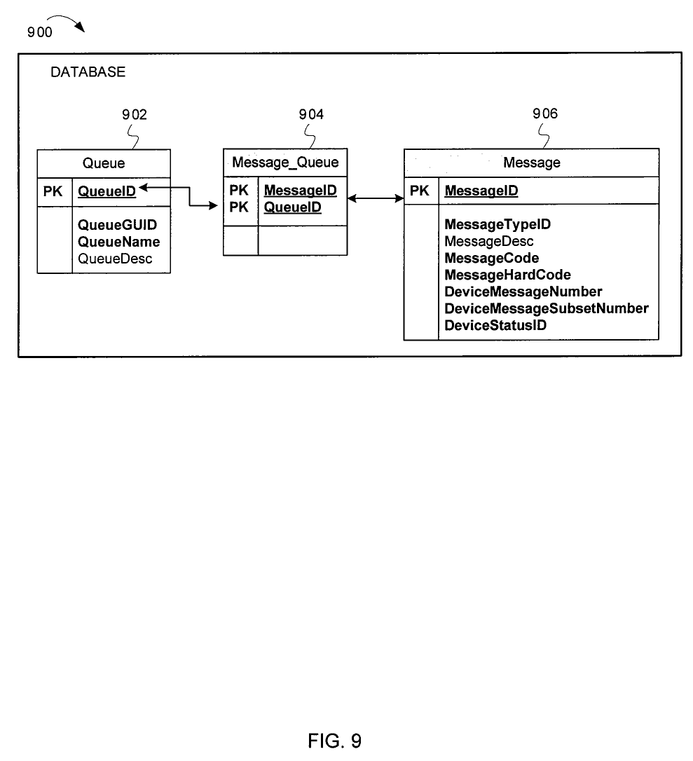

This section describes some implementation details that can be used with certain embodiments of the invention. While this section describes some implementation details, other embodiments of the invention can be implemented differently. In this section, FIG. 9 describes database tables that can be used for passing messages through a wager gaming network.

FIG. 9 is a block diagram illustrating database tables used for routing messages in a wager gaming network, according to exemplary embodiments of the invention. In one embodiment, the database 900 can reside inside the message queue selector 500 (e.g., inside the message queue selection store 504). The database 900 includes three database tables that can be used for routing messages. The Queue table 902 stores information used for opening a message queue and sending/receiving events to/from the message queue.

The Message table 906 stores information for uniquely identifying a message.

The Message_Queue table 904 shows a relationship between a message (identified as MessageID) and message queue to which the message should be sent. If a particular message relates to multiple message queues, the message can be listed multiple times in the MessageQueue table 904. Likewise, a particular message queue can be listed multiple times in the Message_Queue table 904 if multiple messages should be sent to that queue.

In one embodiment, when the database 900 receives a message, the database first determines the unique identifier associated with the message. Next, the database 900 “looks” into the Message table 906 to determine message queues associated with the message. Finally, the database 900 sends the message to each message queue associated with the message.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

1. A method comprising:
receiving a wager gaming message from a wager gaming network device;
selecting a message queue for receiving the wager gaming message, wherein the wager gaming network device does not select the message queue; and
transmitting the wager gaming message to the message queue.

2. The method of claim 1, wherein the wager gaming message is of a message type, and wherein the selecting includes looking-up the message type in a database table, and wherein the database table indicates that the message type is associated with the message queue.

3. The method of claim 2, the database table can be modified to indicate that the message type is associated with one or more different message queues.

4. The method of claim 1, wherein the wager gaming network device is a wagering game machine.

5. The method of claim 1, wherein the wager gaming network device is an application program.

6. The method of claim 1, wherein another wager gaming network device receives the wager gaming message from the message queue.

7. The method of claim 6, wherein the other wager gaming network device is selected from the group consisting of a printer, display device, application program, and site controller.

8. A method comprising:
creating a wager gaming message in a wager gaming network device, wherein the wager gaming message is of a message type, wherein the wager gaming message is for receipt by a message queue associated with the message type, and wherein the wager gaming network device does not transmit the wager gaming message directly to the message queue; and
transmitting the wager gaming message to a message queue selection unit.

9. The method of claim 8, wherein the message queue selection unit includes one or more relational database tables.

10. The method of claim 8, wherein the other wager gaming network device is selected from the group consisting of a printer, display device, application program, and site controller.

11. The method of claim 8, wherein the message type is selected from the group consisting of progressive jackpot message type, multiplayer game message type, security message type, non-progressive jackpot message type, and participation message type.

12. The method of claim 8, wherein the message queue is associated with an input/output device selected from the group consisting of a printer, a video presentation device, and audio presentation device.

13. A wager gaming network device comprising:
a message creation unit to create a wager gaming message for receipt by at least one of a set of message queues; and
a message transmission unit to transmit the wager gaming message to a message queue selection unit, wherein the wager gaming network device does not determine which of the set of message queues receive the wager gaming message.

14. The wager gaming network device of claim 13, wherein the message queue selection unit includes a database, and wherein the message transmission unit transmits the message based on a call to a procedure stored in the database.

15. The wager gaming network device of claim 14, wherein the database determines which of the message queues receive the wager gaming message, and wherein the database transmits the wager gaming message to those of the message queues that are to receive the wager gaming message.

16. The wager gaming network device of claim 13 further comprising:
a message consumption unit to receive another wager gaming message from one of the set of message queues.

17. The wager gaming network device of claim 13, where the message queue selection unit includes a relational database.

18. The wager gaming network device of claim 13, wherein the wager gaming message does not indicate which of the set of message queues are to receive the wager gaming message.

19. An apparatus comprising:
a message receiving unit to receive a wager gaming message from a wager gaming network device;
a message queue selection database including information indicating a set of message queues for receiving the wager gaming message; and
a message queue selection unit to select one of the set of message queues; and
a message transmission unit to transmit the wager gaming message to the one of the set of message queues.

20. The apparatus of claim 19, wherein the message queue selection database includes a relational database table.

21. The apparatus of claim 19, wherein the information can be modified to indicate another set of message queues for receiving the wager gaming message.

22. The apparatus of claim 19, wherein the message queue selection database includes a flat file database.

23. The apparatus of claim 19, wherein the wager gaming message is associated with a message type, and wherein each of the set of message queues is associated with the message type.

24. The apparatus of claim 19, wherein the message queue selection unit to select one of the set of message queues based on the information.
